(19) United States
(12) Patent Application Publication
(10) Pub. No.: US 2004/0196423 A1
(43) Pub. Date: Oct. 7, 2004

(54) Color filter for liquid crystal display

(75) Inventors: Kuang-Lung Kuo, Miao-Li County (TW); Sheng-Shiou Yeh, Miao-Li County (TW)

Correspondence Address: Finnegan, Henderson, Farabow,, Garrett & Dunner, L.L.P., 1300 I Street, N.W., Washington, DC, 20005-3315, US

(73) Assignee: Toppoly Optoelectronics Corp.

(21) Appl. No.: 10/405,611

(22) Filed: Apr. 3, 2003

(51) Int. Cl. G02F 1/133

(52) U.S. Cl. 349/116

(57) ABSTRACT

A liquid crystal display device that includes a substrate, a metal layer formed over the substrate, a color filter layer formed over the metal layer, an insulating film, made of photosensitive material, formed between the metal layer and the color filter layer to physically and electrically isolate the metal layer from the color filter layer, and a pixel electrode formed over the color filter layer.

### DESCRIPTION

1. Technical Field

This invention pertains in general to a liquid crystal display device and, more particularly, to a liquid crystal display device having an insulating film formed between a color filter layer and a metal layer for enhancing insulation between the two layers.

2. Background

A color liquid crystal display (LCD) using a thin film transistor array as a switching element for driving corresponding pixel electrodes is known. The color LCD includes a color filter layer formed on a transistor array, which is termed a “color filter on array” (COA) structure. Each transistor of the transistor array includes a metal layer that electrically couples a source or a drain region of the transistor to a pixel electrode, for example, an indium tin oxide (ITO) transparent electrode. The pixel electrode is electrically coupled to the source or drain region of the transistor through a contact. An insulating film is disposed between the color filter layer and the metal layer to electrically isolate the two layers. Examples of conventional LCD devices having a COA structure include U.S. Pat. No. 6,031,512 (hereinafter the '512 patent) to Kadota et al., entitled “Color Filter Structure for Color Display Device,” and U.S. Pat. No. 6,198,520 (hereinafter the '520 patent) to Kondo et al., entitled “Color Liquid Crystal Display.”

In the '512 patent, inorganic insulating films made of PSG (phospho-silicate glass), NSG (nondoped silicate glass) or the like are formed between a color filter and a source or a drain electrode. In the '520 patent, an inorganic insulating layer made of silicon nitride is disposed between a color filter and a common electrode. The process of fabricating a color LCD having an inorganic insulating film described in the '520 patent may need two photo masks. The '512 patent likewise requires two photo masks in the described process.

FIGS. 1A to 1E show a conventional fabricating process using two photo masks. Referring to FIG. 1A, to fabricate a color LCD 10, the process begins with preparing a transparent substrate 12. A transistor array 14 is formed on transparent substrate 12, in which each transistor (not shown) of transistor array 14 has a metal layer 142 such as a drain electrode. An inorganic insulating film 16 is then formed on transistor array 14. Subsequent to the formation of insulating film 16, in FIG. 1B, a photoresist layer 18 is formed on insulating film 16. A first mask 182 with a desired pattern is used to expose metal layer 142 by etching an unmasked portion of insulating film 16. Referring to FIG. 1C, photoresist 18 is removed and a contact hole 20 is formed. Referring to FIG. 1D, a color filter 22 including a color resin (not shown) and pigments (not shown) dispersed in the color resin is formed on insulating film 16 and fills contact hole 20. A second mask 222 with a desired pattern is used to expose contact hole 20 by etching an unmasked portion of color filter 22. Referring to FIG. 1E, a pixel electrode 24 is formed to electrically couple metal layer 142 to color filter 22.

As described above, the use of inorganic materials for an insulating film requires one thin film process, two photo masks 182 and 222 and one etching process to form color filter 22 of color LCD 10. Such a fabricating method is complicated and cost ineffective. Besides, the color resist contained in color filter 22 may remain in contact hole 20 during the fabrication process and cause contamination.

It is thus desirable to provide a method to fabricate a color LCD device in a simpler manner, and provide a color LCD device thus fabricated.

### SUMMARY OF THE INVENTION

Accordingly, the present invention is directed to LCD devices and processes that obviate one or more of the problems due to limitations and disadvantages of the related art.

Additional features and advantages of the present invention will be set forth in the description which follows, and in part will be apparent from the description, or may be learned by practice of the invention. The objectives and other advantages of the invention will be realized and attained by the devices and methods particularly pointed out in the written description and claims thereof, as well as the appended drawings.

To achieve these and other advantages, and in accordance with the purpose of the invention as embodied and broadly described, there is provided a liquid crystal display device that includes a substrate, a metal layer formed over the substrate, a color filter layer formed over the metal layer, an organic insulating film, made of photosensitive material, formed between the metal layer and the color filter layer to physically and electrically isolate the metal layer from the color filter layer, and a pixel electrode formed over the color filter layer.

In one aspect, the photosensitive material includes a photoresist.

In another aspect, the color filter includes a color resist, and the photoresist has approximately the same exposure wavelength as the color resist.

Also in accordance with the present invention, there is provided a process of forming a liquid crystal display device, wherein the process comprises preparing a substrate, forming a transistor array on the substrate, the transistor array including a metal layer, forming a photosensitive layer on the transistor array, forming a color filter layer on the photosensitive layer, exposing the metal layer provided under the color filter layer and photosensitive layer, and forming a pixel electrode on the color filter layer, wherein the pixel electrode electrically couples the metal layer.

In one aspect, exposing the metal layer comprises masking the color filter layer and photosensitive layer with a desired pattern, and removing a portion of the color filter and photosensitive layer to expose the metal layer.

In another aspect, the photosensitive layer includes a photoresist.

Still in accordance with the present invention, there is provided with a process of forming a liquid crystal display device that includes preparing a substrate, forming a transistor array on the substrate, the transistor array including a metal layer, forming a photosensitive layer on the transistor array, exposing the metal layer provided under the photosensitive layer, forming a color filter layer on the photosensitive layer, exposing the metal layer provided under the color filter layer, and forming a pixel electrode on the color filter layer, wherein the pixel electrode electrically couples the metal layer.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate embodiments consistent with the invention and, together with the description, serve to explain the objects, advantages, and principles of the invention.

In the drawings,

FIGS. 1A to 1E show a conventional process of fabricating a color LCD device;

FIGS. 2A and 2B show a cross-sectional view of a color LCD device in accordance with one embodiment of the present invention;

FIGS. 3A to 3D show a process of fabricating a color LCD device in accordance with one embodiment of the present invention; and

FIGS. 4A to 4F show a process of fabricating a color LCD device in accordance with another embodiment of the present invention.

### DESCRIPTION OF THE EMBODIMENTS

Reference will now be made in detail to embodiments consistent with the invention, examples of which are illustrated in the accompanying drawings. Wherever possible, the same reference numbers will be used throughout the drawings to refer to the same or like parts.

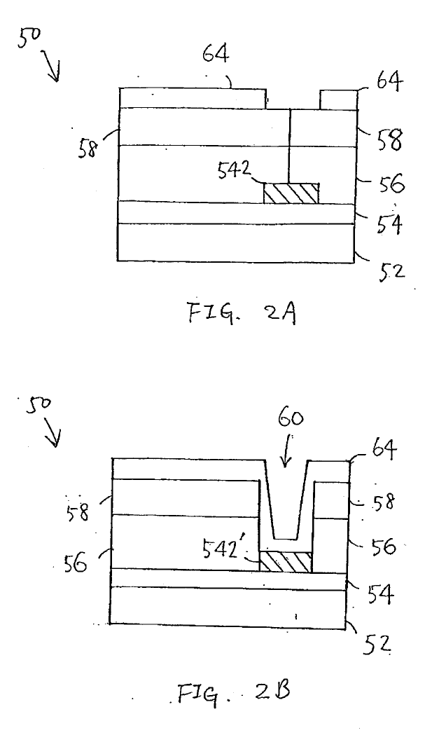

FIGS. 2A and 2B show a cross-sectional view of an LCD device 50 in accordance with one embodiment of the present invention. Referring to FIG. 2A, LCD device 50 includes a transparent substrate 52, a transistor array layer 54 formed on transparent substrate 52, an organic insulating layer 56 formed on transistor layer 54, a color filter layer 58, and a pixel electrode 64. In one embodiment, transparent substrate 52 includes a glass substrate, a quartz substrate or the like. Transistor layer 54 includes a plurality of transistors (not shown), wherein each transistor includes a metal layer 542 that is a common electrode electrically coupled to a source (not shown) or a drain (not shown) of the transistor. Organic insulating layer 56 physically and electrically isolates metal layer 542 from pixel electrode 64. Color filter layer 58 includes a color resist (not shown) composed of an organic photosensitive material containing a pigment dispersed therein.

In one embodiment, organic insulating layer 56 includes photosensitive material, for example, photoresist. The use of an organic insulating layer instead of an inorganic insulating layer enables a simpler method of fabricating a color LCD device, as will be discussed in the following paragraphs. The photoresist has approximately the same exposure wavelength as the color resist of color filter layer 58. In one embodiment, the photoresist has a transmittance greater than about 70% at an exposure wavelength of between about 400 and 700 nm. In another embodiment, the photoresist is a negative photoresist that becomes insoluble when exposed to light and cannot be washed away by developers. In still another embodiment, the color resist has a heat curing sensitivity greater than about 1.5 times that of the photoresist. In yet another embodiment, the color resist has a heat curing sensitivity smaller than about 3 times that of the photoresist.

Referring to FIG. 2B, LCD device 50 includes a metal layer 542′ formed in contact with pixel electrode 64 provided in a contact hole 60. People skilled in the art will understand that metal layer 542 shown in FIG. 2A and metal layer 542′ shown in FIG. 2B may belong to a same source or drain electrode, except that metal layer 542 is disposed under color filter layer 58 and metal layer 542′ under a contact hole region. Metal layer 542′, which functions as a source or a drain electrode of a transistor of transistor array 54, is electrically coupled to pixel electrode 64. Insulating layer 56 and color filter 58 are made of organic photosensitive material.

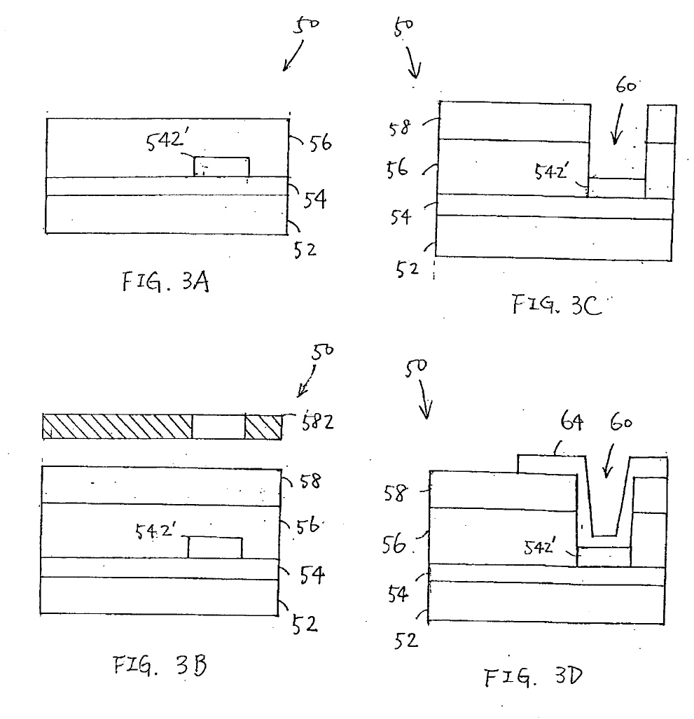

Referring to FIG. 3A, a process consistent with the invention begins with preparing transparent substrate 52. Transistor array 54 is then formed on transparent substrate 52, in which each transistor of transistor array 54 includes metal layer 542′. Organic insulating layer 56, for example, a photosensitive layer, is formed on transistor array 54. In one embodiment, the photosensitive layer includes a photoresist.

Referring to FIG. 3B, color filter layer 58 including a color resist is formed on organic insulating layer 56. In one embodiment, the photoresist has approximately the same exposure wavelength as the color resist of color filter layer 58. The photoresist may also have a transmittance greater than about 70% at an exposure wavelength of between about 400 and 700 nm. In another embodiment, the photoresist is a negative photoresist. In still another embodiment, the color resist has a heat curing sensitivity greater than about 1.5 times that of the photoresist. In yet another embodiment, the color resist has a heat curing sensitivity smaller than about 3 times that of the photoresist. A mask 582 with a desired pattern is provided to expose metal layer 542′ by developing, or removing an unmasked portion of color filter layer 58 and organic insulating layer 56.

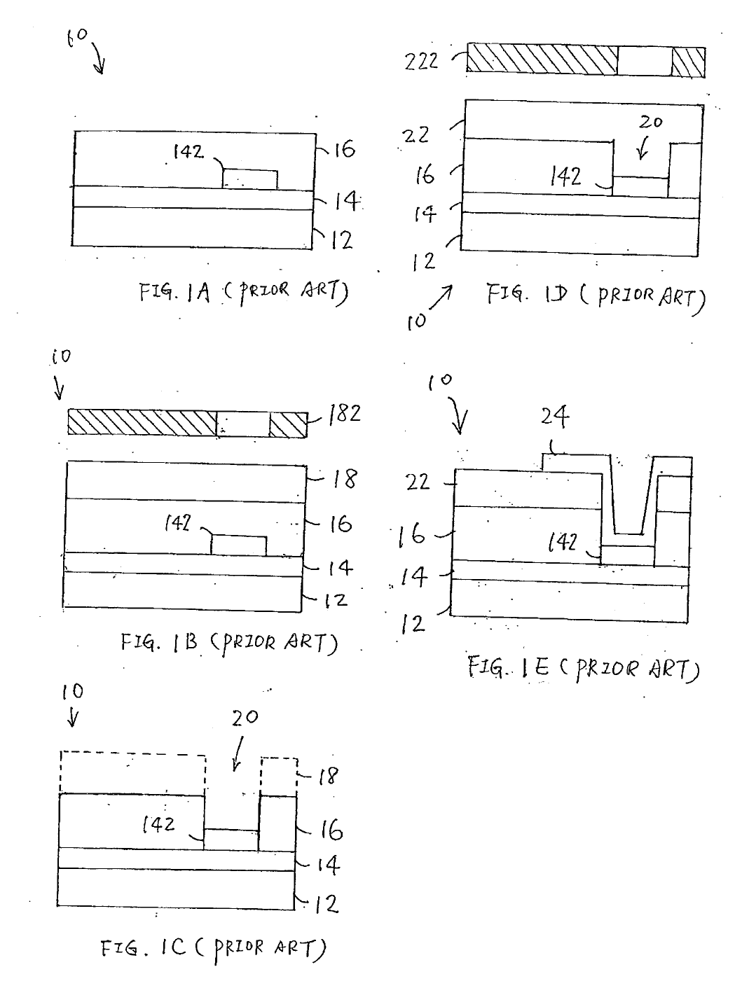

As compared to the method shown in FIG. 1B, the method consistent with the present invention eliminates a thin film process, a mask and an etching process for defining a contact hole in an inorganic insulating layer.

Referring to FIG. 3C, contact hole 60 is formed to expose metal layer 542′. Pixel electrode 64 is formed to electrically couple metal layer 542′, as shown in FIG. 3D.

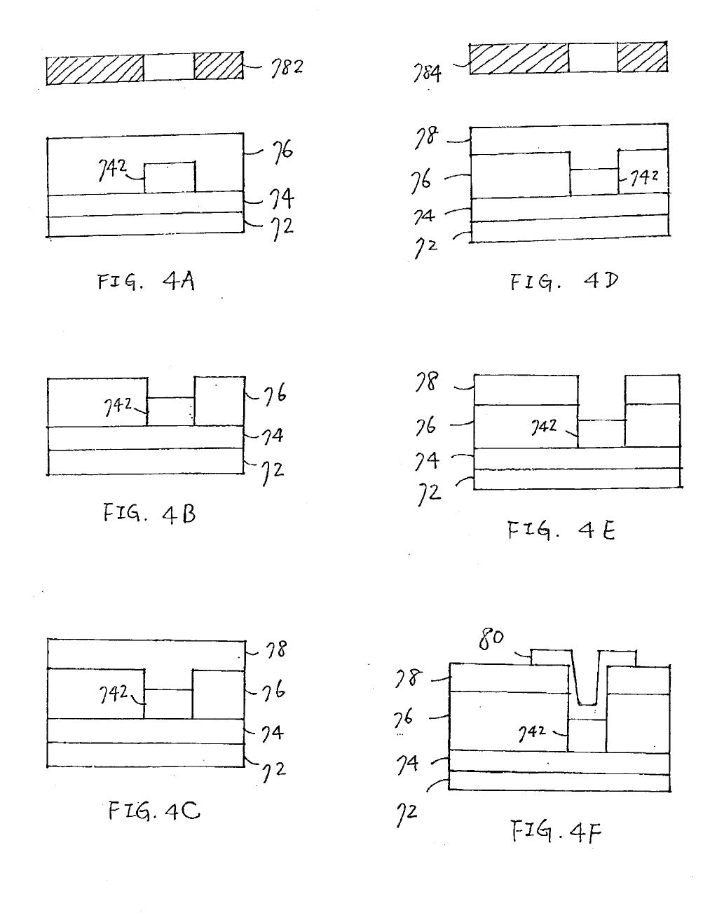

FIGS. 4A to 4F show a process of fabricating a color LCD device in accordance with another embodiment of the present invention. Referring to FIG. 4A, the process begins with preparing a transparent substrate 72 and a transistor array 74 formed on transparent substrate 72, in which each transistor of transistor array 74 includes metal layer 742. Organic insulating layer 76 is then formed on transistor array 74. In one embodiment, organic insulating layer 76 includes a photoresist. A first mask 782 with a desired pattern is provided to expose metal layer 742.

Referring to FIG. 4B, metal layer 742 is exposed by developing, or removing an unmasked portion of organic insulating layer 76. Referring to FIG. 4C, color filter layer 78 including a color resist is formed on organic insulating layer 76. In one embodiment, organic insulating layer 76 has approximately the same exposure wavelength as the color resist of color filter layer 78. Organic insulating layer 76 may also have a transmittance greater than about 70% at an exposure wavelength of between about 400 and 700 nm. In another embodiment, organic insulating layer 76 includes a negative photoresist. In still another embodiment, the color resist has a heat curing sensitivity greater than about 1.5 times that of organic insulating layer 76. In yet another embodiment, the color resist has a heat curing sensitivity smaller than about 3 times that of organic insulating layer 76.

Referring to FIG. 4D, a second mask 784 with a desired pattern is provided to expose metal layer 742. Referring to FIG. 4E, metal layer 742 is exposed by developing, or removing an unmasked portion of color filter layer 78. Subsequently, referring to FIG. 4F, pixel electrode 80 is formed to electrically couple metal layer 742.

As compared to the conventional process, the process consistent with the present invention eliminates a thin film process and an etching process.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A liquid crystal display device comprising:
a substrate;
a metal layer formed over the substrate;
a color filter layer formed over the metal layer;
an insulating film, made of photosensitive material, formed between the metal layer and the color filter layer to physically and electrically isolate the metal layer from the color filter layer; and
a pixel electrode formed over the color filter layer.

2. The device of claim 1, wherein the pixel electrode electrically couples the metal layer.

3. The device of claim 1, wherein the photosensitive material includes a photoresist.

4. The device of claim 1, wherein the photosensitive material includes a negative photoresist.

5. The device of claim 3, wherein the color filter layer includes a color resist, and the photoresist has approximately the same exposure wavelength as the color resist.

6. The device of claim 3, wherein the photoresist has a transmittance greater than about 70% at an exposure wavelength of between about 400 and 700 nm.

7. The device of claim 5, wherein the color resist has a heat curing sensitivity greater than about 1.5 times that of the photoresist.

8. The device of claim 5, wherein the color resist has a heat curing sensitivity smaller than about 3 times that of the photoresist.

9. A process of forming a liquid crystal display device, comprising:
preparing a substrate;
forming a transistor array on the substrate, the transistor array including a metal layer;
forming a photosensitive layer on the transistor array;
forming a color filter layer on the photosensitive layer;
exposing the metal layer provided under the color filter layer and photosensitive layer; and
forming a pixel electrode on the color filter layer, wherein the pixel electrode electrically couples the metal layer.

10. The process of claim 9, wherein exposing the metal layer comprises:
masking the color filter layer and photosensitive layer with a desired pattern; and
removing a portion of the color filter layer and photosensitive layer to expose the metal layer.

11. The process of claim 9, wherein the photosensitive layer includes a photoresist.

12. The process of claim 9, wherein the photosensitive layer includes a negative photoresist.

13. The process of claim 11, wherein the color filter layer includes a color resist, and the photoresist has approximately the same exposure wavelength as the color resist.

14. The process of claim 11, wherein the photoresist has a photosensitivity greater than about 70% at an exposure wavelength of between about 400 and 700 nm.

15. The process of claim 13, wherein the color resist has a heat curing sensitivity greater than about 1.5 times that of the photoresist.

16. The process of claim 13, wherein the color resist has a heat curing sensitivity smaller than about 3 times that of the photoresist.

17. A process of forming a liquid crystal display device, comprising:
preparing a substrate;
forming a transistor array on the substrate, the transistor array including a metal layer;
forming a photosensitive layer on the transistor array;
exposing the metal layer provided under the photosensitive layer;
forming a color filter layer on the photosensitive layer;
exposing the metal layer provided under the color filter layer; and
forming a pixel electrode on the color filter layer, wherein the pixel electrode electrically couples the metal layer.

18. The process of claim 17, wherein the photosensitive layer includes a photoresist.

19. The process of claim 17, wherein the photosensitive layer includes a negative photoresist.

20. The process of claim 17, wherein the color filter layer includes a color resist, and the photoresist layer has approximately the same exposure wavelength as the color resist.
